(19) United States
(12) Patent Application Publication
(10) Pub. No.: US 2024/0063397 A1
(43) Pub. Date: Feb. 22, 2024

(54) ION CONDUCTING MOLECULAR THERMAL BLANKETS

(71) Applicant: FORD GLOBAL TECHNOLOGIES, LLC, Dearborn, MI (US)

(72) Inventors: Kyungjin PARK, Northville, MI (US); Eunsung LEE, Novi, MI (US); Brian UTLEY, Canton, MI (US); Chi PAIK, Grosse Ile, MI (US)

(21) Appl. No.: 17/892,537

(22) Filed: Aug. 22, 2022

(51) Int. Cl. H01M 4/62; H01M 4/505; H01M 4/525; H01M 10/0525; H01M 10/658

(52) U.S. Cl. CPC H01M 4/628; H01M 4/505; H01M 4/525; H01M 10/0525; H01M 10/658; H01M 2004/028

(57) ABSTRACT

A positive electrode material includes a plurality of particles composed of a positive electrode active material and a passivating layer disposed over each particle of the plurality of particles. The passivating layer is thermally insulating and lithium-ion conducting wherein the passivating layer is composed of a carbonate-phosphate composite.

### TECHNICAL FIELD

In at least one aspect, stable positive electrode compositions are provided.

### BACKGROUND

Lithium Ion Battery (LIB) cathodes with high Ni content (Ni>50%) offers high energy density to enable battery electric vehicle (BEV) range and necessary performance features. However, high Ni content cathodes have low thermal stability, and a tendency to release oxygen (02) to the electrolytic solution under a thermal and abuse situation. As the energy density continues to rise in the high nickel cathode technology and competitive market, a solution is necessary to offer higher performance and high stability. The traditional method for non-flammable electrolytes involves strong additives to passivate the electrode active materials and increase the cell's internal resistance, hence leading to poor cell power.

Accordingly, there is a need for alternative methods for making stable positive electrodes used in lithium-ion batteries.

### SUMMARY

In at least one aspect, a positive electrode material is provided. The positive electrode material includes a plurality of particles composed of a positive electrode active material and a passivating layer disposed over at least a subset of the plurality of particles and/or over the positive electrode material. Advantageously, the passivating layer is thermally insulating and lithium-ion conducting wherein the passivating layer is composed of a carbonate-phosphate composite.

In another aspect, a positive electrode is provided. The positive electrode includes a current collector and a positive electrode active layer disposed over the current collector. The positive electrode active layer includes a plurality of particles composed of a positive electrode active material. A passivating layer is disposed over at least a subset of the plurality of particles and/or over the positive electrode material. Advantageously, the passivating layer is thermally insulating and lithium-ion conducting wherein the passivating layer is composed of a carbonate-phosphate composite.

In another aspect, a rechargeable battery including a plurality of lithium-ion battery cells is provided. Each lithium-ion battery cell includes a positive electrode, a negative electrode including a negative active material, and an electrolyte contacting the positive electrode and the negative electrode. The positive electrode includes a current collector, a positive electrode active layer disposed over the current collector. The positive electrode active layer includes a positive electrode active material. A passivating layer is disposed over at least a subset of the plurality of particles and/or over the positive electrode material. Advantageously, the passivating layer is thermally insulating and lithium-ion conducting wherein the passivating layer is composed of a carbonate-phosphate composite.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIGS. 1A and 1B. provides schematic illustrations of a particle composed of a positive electrode material with a protective coating.

FIG. 2A. A schematic cross-section of a positive electrode including a positive electrode material includes a plurality of particles of FIG. 1A-B and coated on one side of a current collector.

FIG. 2B. A schematic cross-section of a positive electrode including a positive electrode material includes a plurality of particles of FIG. 1A-B and coated on both sides of a current collector.

FIG. 2C. A schematic cross-section of a positive electrode including a positive electrode material layer and a passivating layer coated on one side of a current collector.

FIG. 2D. A schematic cross-section of a positive electrode including a positive electrode material layer and a passivating layer coated on both sides of a current collector.

FIG. 3. Schematic cross-section of a battery cell incorporating the electrode of FIG. 2A.

FIG. 4. Schematic cross-section of a battery incorporating the battery cell of FIG. 3.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

The term “positive electrode” means a battery cell electrode from which current flows out when the lithium-ion battery cell or battery is discharged. Sometimes a “positive electrode” is referred to as a “cathode.”

The term “negative electrode” means a battery cell electrode to which current flows in when the lithium-ion battery cell is discharged. Sometimes a “negative electrode” is referred to as an “anode.”

The term “cell” or “battery cell” means an electrochemical cell made of at least one positive electrode, at least one negative electrode, an electrolyte, and a separator membrane.

The term “battery” or “battery pack” means an electric storage device made of at least one battery cell. In a refinement, “battery” or “battery pack” is an electric storage device made of a plurality of battery cells.

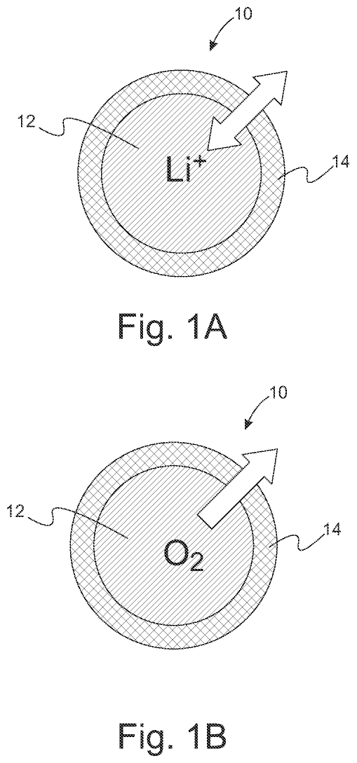

FIGS. 1A and 1B provide schematic illustrations of a particle composed of positive electrode material. The positive electrode material includes a plurality of particles 10 where each particle includes a core 12. Core 12 includes the positive electrode active material. A passivating layer 14 is disposed over each particle 10 of the plurality of particles. Characteristically, the passivating layer is thermally insulating and lithium-ion conducting wherein the passivating layer is composed of a carbonate-phosphate composite. Advantageously, the passivating layer protects the plurality of particles from decomposition and O₂ release.

In a variation, a positive electrode material includes a plurality of particles composed of a positive electrode active material where the passivating layer disposed over each particle of at least a subset of the plurality of particles. In other words, only a subset of or all of the particles may be coated with the passivating layer. Characteristically, the passivating layer is thermally insulating and lithium-ion conducting wherein the passivating layer is composed of a carbonate-phosphate composite.

Typically, the carbonate-phosphate composite includes a carbonate-based solvent or residue thereof and a phosphate. In a refinement, the carbonate-phosphate composite includes a carbonate-based solvent selected from the group consisting of dimethyl carbonate, diethyl carbonate, dipropyl carbonate, methylpropyl carbonate, ethylpropyl carbonate, ethylmethyl carbonate, ethylene carbonate, propylene carbonate, butylene carbonate, vinyl ethylene carbonate, vinylene carbonate and combinations thereof or a residue thereof. In a further refinement, the carbonate-phosphate composite includes a phosphate selected from the group consisting of trimethyl phosphate (TMP), triphenyl phosphate (TPP), triallyl phosphates, and combinations thereof.

In a variation, the passivating layer includes partial surface patches of high Li+ ion conductive film with a low thermally conductive film, either in layers or in-planar combination. In other words, the passivating layer can have a non-uniform thickness profile such that thinner regions can be more efficient in conducting lithium ions therethrough.

In a variation, the passivating layer includes an element that creates vacancies in a sufficient amount to allow effective lithium-ion transport. In a refinement, the element that creates vacancies is boron.

In some variations, the positive electrode material includes nickel in an amount greater than about 50 weight percent of the total weight of the positive electrode material. In a refinement, the positive electrode material includes nickel in an amount from about 35 weight percent to about 85 weight percent of the total weight of the positive electrode material. In some variations, the positive electrode material includes nickel in an amount of at least in increasing order of preference 35 weight percent, 40 weight percent, 45 weight percent, 50 weight percent, or 55 weight percent of the total weight of the positive electrode material. In a refinement, the positive electrode material includes nickel in an amount of at most in increasing order of preference 90 weight percent, 85 weight percent, 80 weight percent, 75 weight percent, or 70 weight percent of the total weight of the positive electrode material. In other refinement, the positive electrode material includes a component selected from the group consisting of nickel cobalt manganese oxide (NCM), nickel cobalt aluminum oxide (NCA), nickel cobalt manganese aluminum oxide (NCMA), and combinations thereof.

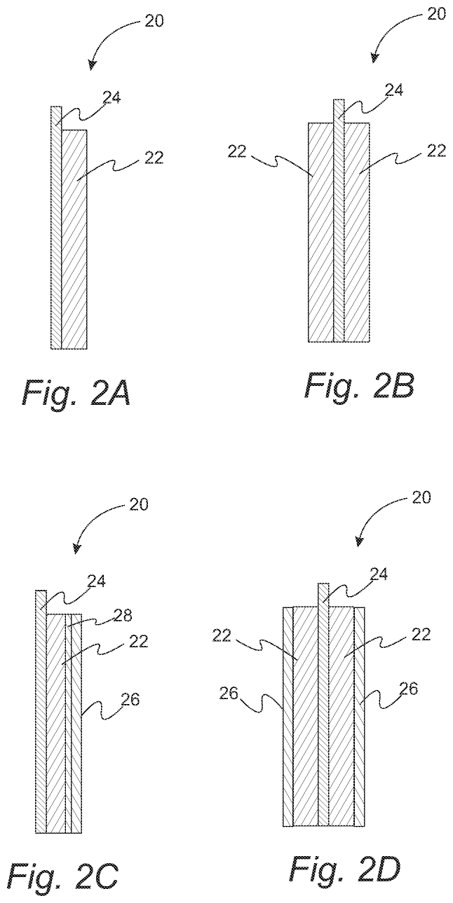

Referring to FIGS. 2A and 2B, schematics of a positive electrode that can include the positive electrode material described above are provided. Positive electrode 20 includes positive electrode active material layer 22 of positive electrode active material disposed over and typically contacting positive electrode current collector 24. In a refinement, the positive electrode active material includes the positive electrode material described above with respect to FIGS. 1A and 1B. Typically, positive electrode current collector 24 is a metal plate or metal foil composed of a metal such as aluminum, copper, platinum, zinc, titanium, nickel, tantalum, and the like. Currently, aluminum is most commonly used for the positive electrode current collector. The positive electrode active material includes the positive electrode materials described above.

Referring to FIGS. 2C and 2D, schematics of a positive electrode that may or may not include the positive electrode material described above are provided. As set forth above, positive electrode 20 includes positive electrode active material layer 22 that includes positive electrode active material disposed over and typically contacting positive electrode current collector 24. Passivating layer 26 is disposed over positive electrode active material layer 22. Characteristically, passivating layer 26 is a solid electrolyte interphase. As set forth above, passivating layer 26 can be thermally insulating and lithium-ion conducting wherein the passivating layer is composed of a carbonate-phosphate composite. In a refinement, an electrically and/or lithium-ion more conductive layer 28 is disposed over and optionally contacts electrode active material layer 22. Therefore, the electrically and/or lithium-ion more conductive layer 28 is interposed between electrode active material layer 22 and passivating layer 26. An example of an electrically and/or lithium-ion more conductive layer 28 can be composed of polythiophene. Typically, positive electrode current collector 24 is a metal plate or metal foil composed of a metal such as aluminum, copper, platinum, zinc, titanium, and the like. Currently, aluminum is most commonly used for the positive electrode current collector. The positive electrode active material includes the positive electrode materials described above. It should also be appreciated that a passivating layer can also form over the negative electrode active layer and an electrically and/or lithium-ion more conductive layer interposed between the negative electrode active material layer 22 and passivating layer 26.

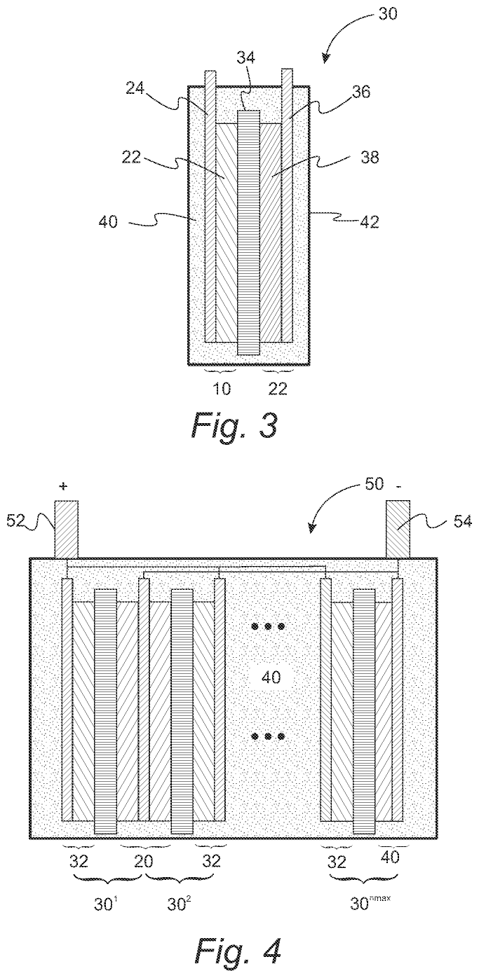

With reference to FIG. 3, a schematic of a rechargeable lithium-ion battery cell incorporating the positive electrode of FIGS. 2A, 2B, 2C, and 2D is provided. Battery cell 30 includes positive electrode 20 as described above, negative electrode 32, and separator 34 interposed between the positive electrode and the negative electrode. Negative electrode 32 includes a negative electrode current collector 36 and a negative active material layer 38 disposed over and typically contacting the negative current collector. Typically, negative electrode current collector 36 is a metal plate or metal foil composed of a metal such as aluminum, copper, platinum, zinc, titanium, tantalum, nickel and the like. Currently, copper is most commonly used for the negative electrode current collector. The battery cell is immersed in electrolyte 40 which is enclosed by battery cell case 42. Electrolyte 40 imbibes into separator 34. In other words, the separator 34 includes the electrolyte thereby allowing lithium ions to move between the negative and positive electrodes. The electrolyte includes a non-aqueous organic solvent and a lithium salt. The non-aqueous organic solvent serves as a medium for transmitting ions taking part in the electrochemical reaction of a battery.

With reference to FIG. 4, a schematic of a rechargeable lithium-ion battery incorporating the positive electrode of FIGS. 2A, 2B, 2C, and 2D and the battery cells of FIG. 2 is provided. Rechargeable lithium-ion battery 50 includes at least one battery cell of the design in FIG. 2. Typically, comprising rechargeable lithium-ion battery 50 includes at least one battery cell 30′ of the design of FIG. 2. Each lithium-ion battery cell 30′ includes a positive electrode 20 which includes the positive electrode material set forth above, a negative electrode 32 which includes a negative active material, and an electrolyte 40, where i is an integer label for each battery cell. The label i runs from 1 to nmax, where nmax is the total number of battery cells in rechargeable lithium-ion battery 50. The electrolyte 40 includes a non-aqueous organic solvent and a lithium salt. The non-aqueous organic solvent serves as a medium for transmitting ions taking part in the electrochemical reaction of a battery. The plurality of battery cells can be wired in series, in parallel, or a combination thereof. The voltage output from battery 50 is provided across terminals 52 and 54.

The passivating layers set forth can be formed by applying one or more charging cycles to a newly formed battery cell. The container holding the battery cells includes an electrolyte (carbonate-based solvent) and a phosphate additive as described above. In a variation, the electrolyte is added and then one or more charging cycles are run. The phosphate is then added and one or more additional charging cycles are run. Characteristically, a sufficient number of charging cycles are run to form the passivating layer. In some refinement, the charging of the cell is performed over 1 to 30 minutes such that a passivating layer having a non-uniform thickness (i.e., patches) is formed.

Referring to FIGS. 3 and 4, separator 34 physically separates the negative electrode 32 from the positive electrode 20 thereby presenting shorting while allowing the transport of lithium ions for charging and discharging. Therefore, separator 34 can be composed of any material suitable for this purpose. Examples of suitable materials from which separator 34 can be composed include but are not limited to polytetrafluoroethylene (e.g., TEFLON®), glass fiber, polyester, polyethylene, polypropylene, and combinations thereof. Separator 34 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

Referring to FIGS. 3 and 4, electrolyte 40 includes a lithium salt dissolved in the non-aqueous organic solvent. Therefore, electrolyte 40 includes lithium ions that can intercalate into the positive electrode active material during discharging and into the anode active material during charging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, LiCF₃SO₃, LiN(SO₂F)₂, LiN(SO₂CF₃)₂ and combinations thereof. In a refinement, the electrolyte includes the lithium salt in concentrations from about 0.1 M to about 2.0 M.

Still referring to FIGS. 3 and 4, the electrolyte includes a non-aqueous organic solvent and a lithium salt. Advantageously, the non-aqueous organic solvent serves as a medium for transmitting ions, and in particular, lithium ions participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methyl propyl carbonate, ethyl propyl carbonate, ethyl methyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvent include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, electrolyte 40 can further include vinylene carbonate or an ethylene carbonate-based compound to increase battery cycle life.

Referring to FIGS. 2, 3, and 4, the negative electrode and the positive electrode can be fabricated by methods known to those skilled in the art of lithium-ion batteries. Typically, an active material (e.g., the positive or negative active material) is mixed with a conductive material, and a binder in a solvent (e.g., N-methylpyrrolidone) forming a slurry and coating the composition on a current collector. The electrode manufacturing method is well known and thus is not described in detail in the present specification. The solvent includes N-methylpyrrolidone and the like but is not limited thereto.

Referring to FIGS. 1, 2, 3, and 4, the positive electrode active material layer 22 includes one or more of the positive electrode material set forth above, a binder, and a conductive material. The binder can increase the binding properties of positive electrode active material particles with one another and with the positive electrode current collector 24. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 20 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, 3, and 4, the negative active material layer 26 includes a negative active material, includes a binder, and optionally a conductive material. The negative active materials used herein can be those negative materials known to one skilled in the art of lithium-ion batteries. Negative active materials include but are not limited to, carbon-based negative active materials, silicon-based negative active materials, lithium and lithium alloys and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 2.0. Mixtures of carbon-based negative active materials, silicon-based negative active materials can also be used for the negative active material.

The negative electrode binder binds negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamide-imide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A positive electrode material comprising:
a plurality of particles composed of a positive electrode active material; and
a passivating layer disposed over each particle of at least a subset of the plurality of particles, the passivating layer being thermally insulating and lithium-ion conducting wherein the passivating layer is composed of a carbonate-phosphate composite.

2. The positive electrode material of claim 1, wherein the carbonate-phosphate composite includes a carbonate-based solvent selected from the group consisting of dimethyl carbonate, diethyl carbonate, dipropyl carbonate, methylpropyl carbonate, ethylpropyl carbonate, ethylmethyl carbonate, ethylene carbonate, propylene carbonate, butylene carbonate, and combinations thereof or a residue thereof.

3. The positive electrode material of claim 2, wherein the carbonate-phosphate composite includes a phosphate selected from the group consisting of trimethyl phosphate (TMP), triphenyl phosphate (TPP), triallyl phosphates, and combinations thereof.

4. The positive electrode material of claim 1 wherein the passivating layer includes an element that creates vacancies in a sufficient amount to allow effective lithium-ion transport.

5. The positive electrode material of claim 3, wherein the passivating layer includes patches that conduct lithium ion

6. The positive electrode material of claim 1, wherein the positive electrode material includes nickel in an amount greater than about 50 weight percent of the total weight of the positive electrode material.

7. The positive electrode material of claim 1, wherein the positive electrode material includes nickel in an amount from about 35 weight percent to about 85 weight percent of the total weight of the positive electrode material.

8. The positive electrode material of claim 1, wherein the positive electrode material includes a component selected from the group consisting of nickel cobalt manganese oxide (NCM), nickel cobalt aluminum oxide (NCA), nickel cobalt manganese aluminum oxide (NCMA), and combinations thereof.

9. A positive electrode comprising:
a current collector;
a positive electrode active layer disposed over the current collector, the positive electrode active layer including a plurality of particles composed of a positive electrode active material; and
a passivating layer disposed over each particle of at least a subset of the plurality of particles and/or over the positive electrode material, the passivating layer being thermally insulating and lithium-ion conducting wherein the passivating layer is composed of a carbonate-phosphate composite.

10. The positive electrode of claim 9, wherein the carbonate-phosphate composite includes a carbonate-based solvent selected from the group consisting of dimethyl carbonate, diethyl carbonate, dipropyl carbonate, methylpropyl carbonate, ethylpropyl carbonate, ethylmethyl carbonate, ethylene carbonate, propylene carbonate, butylene carbonate, and combinations thereof or a residue thereof and a phosphate selected from the group consisting of trimethyl phosphate (TMP), triphenyl phosphate (TPP), triallyl phosphates, and combinations thereof.

11. The positive electrode of claim 9, wherein the passivating layer has a non-uniform thickness profile.

12. The positive electrode of claim 9, wherein an electrically and/or lithium-ion conductive layer is interposed between the positive electrode active layer and the passivating layer.

13. The positive electrode of claim 9, wherein the passivating layer includes an element that creates vacancies in a sufficient amount to allow effective lithium-ion transport.

14. The positive electrode of claim 9, wherein the positive electrode active material includes nickel in an amount greater than about 50 weight percent of the total weight of the positive electrode active material.

15. A rechargeable battery comprising a plurality of lithium-ion battery cells, each lithium-ion battery cell including:
a positive electrode comprising:
a current collector;
a positive electrode active layer disposed over the current collector, the positive electrode active layer including a positive electrode active material; and
a passivating layer disposed over each particle of at least a subset of the plurality of particles and/or over the positive electrode material, the passivating layer being thermally insulating and lithium-ion conducting wherein the passivating layer is composed of a carbonate-phosphate composite;
a negative electrode including a negative active material; and
an electrolyte contacting the positive electrode and the negative electrode.

16. The rechargeable battery of claim 15, wherein the carbonate-phosphate composite includes a carbonate-based solvent selected from the group consisting of dimethyl carbonate, diethyl carbonate, dipropyl carbonate, methylpropyl carbonate, ethylpropyl carbonate, ethylmethyl carbonate, ethylene carbonate, propylene carbonate, butylene carbonate, and combinations thereof or a residue thereof and a phosphate selected from the group consisting of trimethyl phosphate (TMP), triphenyl phosphate (TPP), triallyl phosphates, and combinations thereof.

17. The rechargeable battery of claim 15, wherein the passivating layer has a non-uniform thickness profile.

18. The rechargeable battery of claim 15, wherein an electrically and/or lithium-ion conductive layer is interposed between the positive electrode active layer and the passivating layer.

19. The rechargeable battery of claim 15, wherein the positive electrode active material includes nickel in an amount greater than about 50 weight percent of the total weight of the positive electrode active material.

20. The positive electrode of claim 15, wherein the positive electrode active material includes nickel in an amount greater than about 50 weight percent of the total weight of the positive electrode active material.
